(19) United States
(12) Patent Application Publication
(10) Pub. No.: US 2017/0220664 A1
(43) Pub. Date: Aug. 3, 2017

(54) SYSTEMS AND METHODS FOR LOGGING AND CATEGORIZING PERFORMANCE EVENTS

(71) Applicant: Dell Software Inc., Aliso Viejo, CA (US)

(72) Inventors: Denis Viktorovich RULEV, St. Petersburg (RU); Oleg Anatolievich SHEVNIN, St. Petersburg (RU); Volodymyr Fedorovich LAVRENCHUK, St. Petersburg (RU)

(73) Assignee: Dell Software Inc., Aliso Viejo, CA (US)

(21) Appl. No.: 15/136,464

(22) Filed: Apr. 22, 2016

(30) Foreign Application Priority Data
Feb. 1, 2016 (RU) 2016103154

(51) Int. Cl. G06F 17/30; H04L 12/26; G06F 17/27

(52) U.S. Cl. CPC G06F 17/30598; G06F 17/2705; H04L 43/08

(57) ABSTRACT

In one embodiment, a method includes executing a first logging process, a second logging process and a categorization process in parallel on a computer system, wherein the first logging process identifies computer-performance events at a monitored resource. The method further includes the second logging process monitoring the first logging process for the computer-performance events. The method also includes, as particular computer-performance events at the monitored resource are detected, the second logging process recording the particular computer-performance events in a data store. The method additionally includes the categorization process parsing log entries of the second log. Further, the method includes the categorization process dynamically determining processing rules that are applicable to the parsed log entries. Also, the method includes the categorization process categorizing the parsed log entries using the dynamically determined processing rules. Moreover, the method includes the categorization process publishing a result of the categorizing to an interface.

### BACKGROUND

Technical Field

The present disclosure relates generally to performance monitoring and more particularly, but not by way of limitation, to systems and methods for logging and categorizing performance events.

History of Related Art

Many software products use various techniques to troubleshoot their behavior and overall execution. One of the commonly used techniques is logging. Logging, however, results in an abundance of information that can be difficult to process.

Moreover, as the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment, a method includes executing a first logging process, a second logging process and a categorization process in parallel on a computer system, wherein the first logging process identifies computer-performance events at a monitored resource. The method further includes the second logging process monitoring the first logging process for the computer-performance events. The method also includes, responsive to the monitoring, as particular computer-performance events at the monitored resource are detected, the second logging process recording the particular computer-performance events in a data store. The method additionally includes the categorization process parsing log entries of the second log. Further, the method includes, responsive to the parsing, the categorization process dynamically determining processing rules that are applicable to the parsed log entries. Also, the method includes the categorization process categorizing the parsed log entries using the dynamically determined processing rules. Moreover, the method includes the categorization process publishing a result of the categorizing to an interface.

In one embodiment, an information handling system includes a processor. The processor is operable to implement a method. The method includes executing a first logging process, a second logging process and a categorization process in parallel on a computer system, wherein the first logging process identifies computer-performance events at a monitored resource. The method further includes the second logging process monitoring the first logging process for the computer-performance events. The method also includes, responsive to the monitoring, as particular computer-performance events at the monitored resource are detected, the second logging process recording the particular computer-performance events in a data store. The method additionally includes the categorization process parsing log entries of the second log. Further, the method includes, responsive to the parsing, the categorization process dynamically determining processing rules that are applicable to the parsed log entries. Also, the method includes the categorization process categorizing the parsed log entries using the dynamically determined processing rules. Moreover, the method includes the categorization process publishing a result of the categorizing to an interface.

In one embodiment, a computer-program product includes a non-transitory computer-usable medium having computer-readable program code embodied therein. The computer-readable program code is adapted to be executed to implement a method. The method includes executing a first logging process, a second logging process and a categorization process in parallel on a computer system, wherein the first logging process identifies computer-performance events at a monitored resource. The method further includes the second logging process monitoring the first logging process for the computer-performance events. The method also includes, responsive to the monitoring, as particular computer-performance events at the monitored resource are detected, the second logging process recording the particular computer-performance events in a data store. The method additionally includes the categorization process parsing log entries of the second log. Further, the method includes, responsive to the parsing, the categorization process dynamically determining processing rules that are applicable to the parsed log entries. Also, the method includes the categorization process categorizing the parsed log entries using the dynamically determined processing rules. Moreover, the method includes the categorization process publishing a result of the categorizing to an interface.

### BRIEF DESCRIPTION OF THE DRAWINGS

A more complete understanding of the method and apparatus of the present disclosure may be obtained by reference to the following Detailed Description when taken in conjunction with the accompanying Drawings wherein:

FIG. 1 illustrates an example computing environment for implementing an embodiment of a computing management system.

FIG. 2 illustrates an example of an information handling system.

FIG. 3 illustrates an example of a process for identifying computer-performance events.

FIG. 4 illustrates an example of a process for performing supplemental logging of computer-performance events.

FIG. 5 illustrates an example of a process for performing supplemental logging of computer-performance events.

### DETAILED DESCRIPTION

In various embodiments, a computing management system includes a logging engine that gathers and records information, at runtime, about computer-performance events on one or more resources. In various cases, logging can be performed to files, databases, user datagram protocol (UDP) endpoints, etc. In some embodiments, resulting logs may then parsed and analyzed by developers, customers, other users, etc.

A useful aspect of log analysis can be some manner of grouping of log entries, or events. The grouping can be used during analysis to get an idea of most critical or problematic parts of a system. This knowledge can then be used for troubleshooting. However, doing categorization in real-time, during execution, that is beyond what the logging engine provides, is technically difficult. Performing categorization as a post-processing step, typically manually, generally fails to provide additional information in a timely manner.

The present disclosure describes examples of executing separate event logging, supplemental logging and categorization processes in parallel. In certain embodiments, the categorization process can monitor the event logging process and create a supplemental log that, in various embodiments, is more lightweight than an event log resulting from the event logging process. Additionally, in certain embodiments, the categorization process can iteratively categorize entries in the supplemental log using dynamically updatable processing rules. Advantageously, in various embodiments, the categorization process can be customized during execution of monitored resources.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

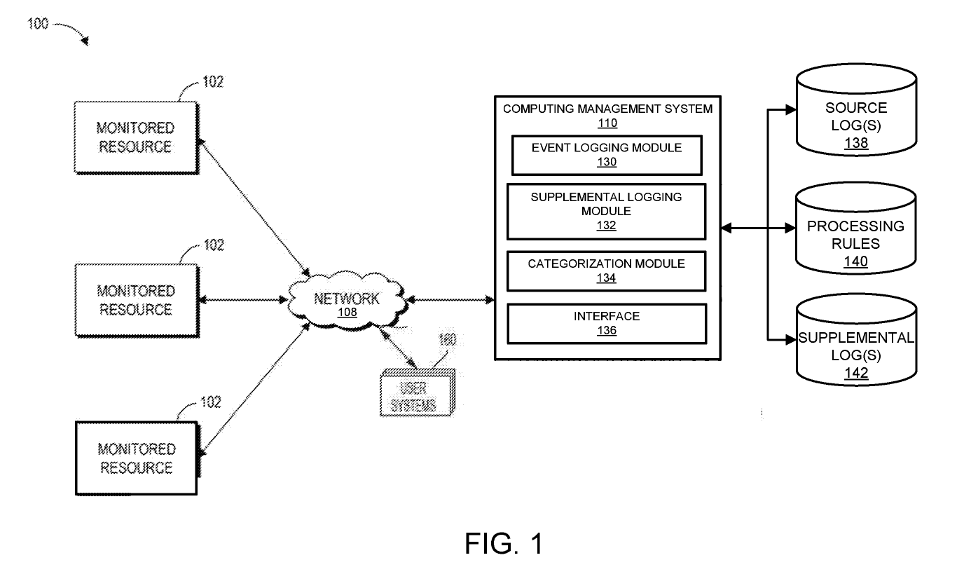

FIG. 1 illustrates an example computing environment 100 for implementing an embodiment of a computing management system 110. The computing environment 100 includes the computing management system 110, resources 102, user systems 160, and data stores 138, 140 and 142, each of which is operable to communicate over a network 108. The network 108 may be a private network, a public network, a local or wide area network, a portion of the Internet, combinations of the same, and/or the like.

The computing management system 110 can manage and/or monitor the resources 102 for performance tuning reasons, troubleshooting, or other reasons. The managed resources 102 may, for instance, include devices in a data center or in a plurality of data centers. Some examples of the managed resources 102 include the following: information handling systems, virtual machines, servers, web servers, application servers, databases, applications, processors, memories, hard drives or other storage devices, peripherals, software components, database tables, tablespaces in a database, application tiers, network switches and other network hardware, combinations of same, and/or the like. The managed resources 102 can be geographically separate or co-located.

In the depicted embodiment, the computing management system 110 includes an event logging module 130, a supplemental logging module 132, a categorization module 134, and an interface 136. Each of these components can be implemented with hardware and/or software, including (optionally) virtual machines. In an example, the computing management system 110 can be implemented as a single management server. In another example, the computing management system 110 can be implemented in a plurality of virtual or physical servers, which may or may not be geographically co-located. For instance, the computing management system 110 and/or other aspects of the computing environment 100 may be hosted in a cloud-based hosting service such as the Azure™ service provided by Microsoft® or the EC2™ platform provided by Amazon®.

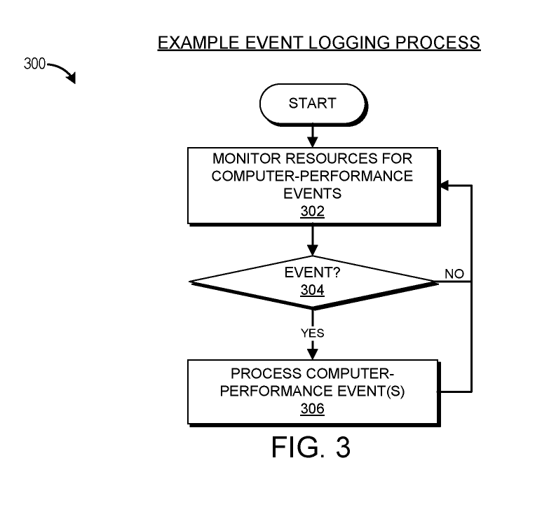

In certain embodiments, the event logging module 130, the supplemental logging module 132 and the categorization module 134 can each be invoked as separate, parallel computing processes on the computing management system 110. In particular, the event logging module 130 can identify computer-performance events that occur in the resources 102. In general, computer-performance events can be detected occurrences or actions that deviate from what is expected, merit special handling, and/or warrant tracking. For example, in various cases, events can include errors, exceptions, completed transactions, combinations of same and/or the like. The event logging module 130 can store information related to identified events in the data store 138. The resources 102 can each be a source of logfile data. Example operation of the event logging module 130 will be described in relation to FIG. 3.

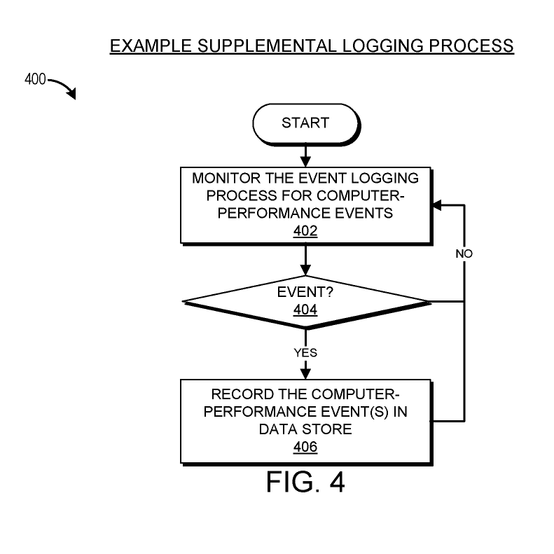

The supplemental logging module 132 can monitor execution of the event logging module 130 for computer-performance events identified thereby. In some embodiments, the supplemental logging module 132 can check for new computer-performance events on a periodic basis (e.g., every five minutes, hourly, etc.). Information related to identified new events can be stored in a supplemental log in the data store 142. In certain embodiments, the supplemental logging module 132 can be considered a pluggable module relative to the event logging module 130. For example, in some implementations, the data store 142 can be file-based storage. Advantageously, in some implementations, file-based storage can enable information to be stored and updated reliably regardless of unexpected failures such as application crashes or power outages. Example operation of the supplemental logging module 132 will be described in relation to FIG. 4.

The categorization module 134 can parse log entries produced by the supplemental logging module 132. For example, the categorization module 134 can retrieve and parse log entries stored in the data store 142. Thereafter, the categorization module 134 can use processing rules stored in the data store 140 to categorize or otherwise relate together the parsed log entries in a way which the log entries were not already grouped or related together by the event logging module 130 or the supplemental logging module 132. In an example, the processing rules of the data store 140 could be directed to identifying log entries related to a same transaction or request, log entries related to particular type of event (e.g., permissions issues, connectivity issues, etc.), combinations of same and/or the like.

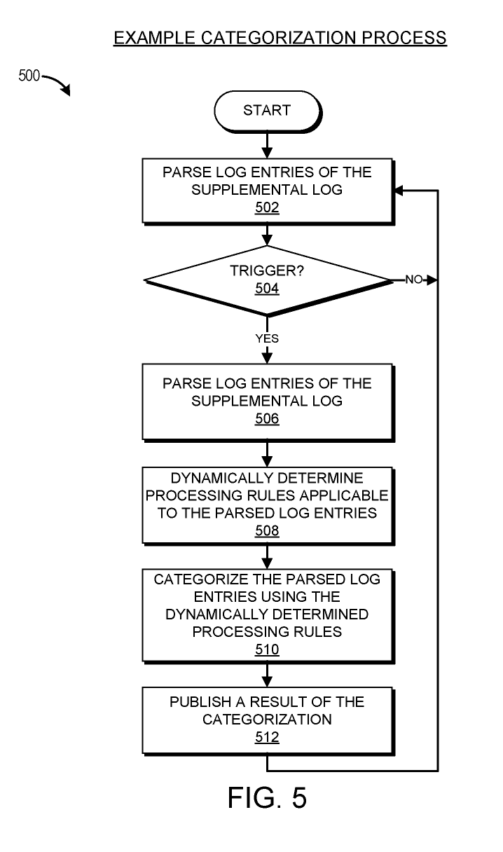

In some cases, the processing rules of the data store 140 can include one or more Boolean expressions that evaluates to true or false. For example, each Boolean expression can specify absolute values and/or ranges of values for each of fields of the parsed log entries. The values and/or ranges of values can be connected by Boolean operators such as, for example, AND, OR, and NOT. In addition, or alternatively, the rules of the data store 140 can include dynamic decision scripts (e.g., using POWERSHELL scripting technology). Additionally, in various implementations, the processing rules of the data store 142 can be dynamically updated at runtime. For example, the categorization module 134 can periodically receive a new or updated processing rule during execution (e.g., via the interface 136) and store the new or updated processing rule in the data store 140. Advantageously, in these implementations, the new or updated processing rule can be dynamically determined and used in a next iteration of categorization by the categorization module 134. Thus, a current set of processing rules can be applied each time the categorization module 134 performs categorization. Example operation of the categorization module 134 will be described in greater detail with respect to FIG. 5.

Advantageously, in certain embodiments, the supplemental logging module 132 and the categorization module 134 can greatly improve event-processing efficiency. For example, in some cases, the supplemental logging module 132 can filter performance events that are logged, thereby reducing a number of events that are processed by the categorization module 134. The filter can be based on certain types of events, events produced by a particular source, etc.

In certain embodiments, the interface 136 can provide information related to the categorized log entries in relation a performance report or dashboard. In other embodiments, the interface 136 can generate regular or on-demand reports related to the categorized log entries. In various cases, these reports can provide a snapshot of some or all of the resources 102. The interface 136 can publish reports or other generated information, for example, to a web page, dashboard, and/or the like. For example, in some embodiments, the interface 136 can generate and/or cause to be displayed data generated by the categorization module 134. Additionally, or alternatively, the interface 136 can publish the above-described information, or similar information, to files, databases, user datagram protocol (UDP) endpoints, combinations of same and/or the like. In various cases, the interface 136 can be triggered by and work in conjunction with the categorization module 136. In some embodiments, the interface 136 can conform to certain constraints of representational state transfer (REST) and thus be considered a RESTful interface.

The web page, user dashboard or other user interface(s) output, for example, by the interface 136, can be accessed by the user systems 160. The interface 136 can also provide a user interface, for instance, that allows the users of the user systems 160 to provide configuration updates, for example, in the form of new or updated processing rules as described above. The user systems 160 can include any type of computing device, including information handling systems such as desktops, laptops, tablets, smartphones, PDAs, to name a few.

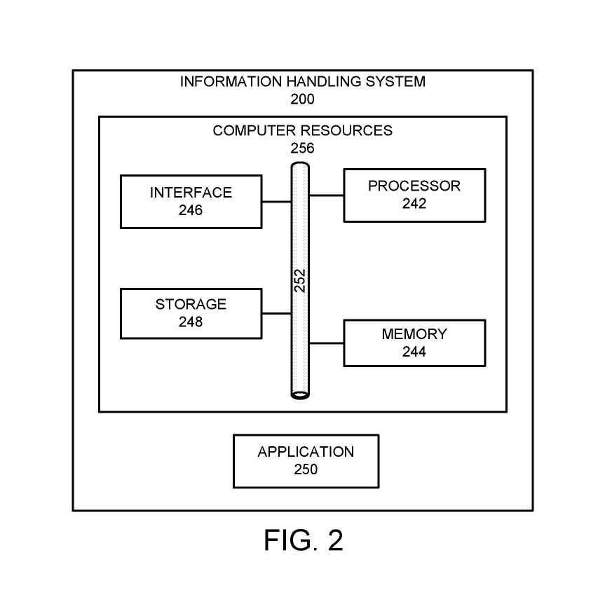

FIG. 2 illustrates an example of an information handling system 200 that, in some cases, can be representative, for example, of the resources 102, the computing management system 110 and/or the user systems 160. The information handling system 200 includes an application 250 operable to execute on computer resources 256. The application 250 can be similar, for example, to event logging module 130, the supplemental logging module 132, the categorization module 134 and, in some cases, the interface 136. In particular embodiments, the information handling system 200 may perform one or more steps of one or more methods described or illustrated herein. In particular embodiments, one or more computer systems may provide functionality described or illustrated herein. In particular embodiments, encoded software running on one or more computer systems may perform one or more steps of one or more methods described or illustrated herein or provide functionality described or illustrated herein.

The components of the information handling system 200 may comprise any suitable physical form, configuration, number, type and/or layout. As an example, and not by way of limitation, the information handling system 200 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a wearable or body-borne computer, a server, or a combination of two or more of these. Where appropriate, the information handling system 200 may include one or more computer systems; be unitary or distributed; span multiple locations; span multiple machines; or reside in a cloud, which may include one or more cloud components in one or more networks.

In the depicted embodiment, the information handling system 200 includes a processor 242, memory 244, storage 248, interface 246, and bus 252. Although a particular information handling system is depicted having a particular number of particular components in a particular arrangement, this disclosure contemplates any suitable information handling system having any suitable number of any suitable components in any suitable arrangement.

Processor 242 may be a microprocessor, controller, or any other suitable computing device, resource, or combination of hardware, software and/or encoded logic operable to execute, either alone or in conjunction with other components, (e.g., memory 244), the application 250. Such functionality may include providing various features discussed herein. In particular embodiments, processor 242 may include hardware for executing instructions, such as those making up the application 250. As an example and not by way of limitation, to execute instructions, processor 242 may retrieve (or fetch) instructions from an internal register, an internal cache, memory 244, or storage 248; decode and execute them; and then write one or more results to an internal register, an internal cache, memory 244, or storage 248.

In particular embodiments, processor 242 may include one or more internal caches for data, instructions, or addresses. This disclosure contemplates processor 242 including any suitable number of any suitable internal caches, where appropriate. As an example and not by way of limitation, processor 242 may include one or more instruction caches, one or more data caches, and one or more translation lookaside buffers (TLBs). Instructions in the instruction caches may be copies of instructions in memory 244 or storage 248 and the instruction caches may speed up retrieval of those instructions by processor 242. Data in the data caches may be copies of data in memory 244 or storage 248 for instructions executing at processor 242 to operate on; the results of previous instructions executed at processor 242 for access by subsequent instructions executing at processor 242, or for writing to memory 244, or storage 248; or other suitable data. The data caches may speed up read or write operations by processor 242. The TLBs may speed up virtual-address translations for processor 242. In particular embodiments, processor 242 may include one or more internal registers for data, instructions, or addresses. Depending on the embodiment, processor 242 may include any suitable number of any suitable internal registers, where appropriate. Where appropriate, processor 242 may include one or more arithmetic logic units (ALUs); be a multi-core processor; include one or more processors 242; or any other suitable processor.

Memory 244 may be any form of volatile or non-volatile memory including, without limitation, magnetic media, optical media, random access memory (RAM), read-only memory (ROM), flash memory, removable media, or any other suitable local or remote memory component or components. In particular embodiments, memory 244 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Memory 244 may include one or more memories 244, where appropriate. Memory 244 may store any suitable data or information utilized by the information handling system 200, including software embedded in a computer readable medium, and/or encoded logic incorporated in hardware or otherwise stored (e.g., firmware). In particular embodiments, memory 244 may include main memory for storing instructions for processor 242 to execute or data for processor 242 to operate on. In particular embodiments, one or more memory management units (MMUs) may reside between processor 242 and memory 244 and facilitate accesses to memory 244 requested by processor 242.

As an example and not by way of limitation, the information handling system 200 may load instructions from storage 248 or another source (such as, for example, another computer system) to memory 244. Processor 242 may then load the instructions from memory 244 to an internal register or internal cache. To execute the instructions, processor 242 may retrieve the instructions from the internal register or internal cache and decode them. During or after execution of the instructions, processor 242 may write one or more results (which may be intermediate or final results) to the internal register or internal cache. Processor 242 may then write one or more of those results to memory 244. In particular embodiments, processor 242 may execute only instructions in one or more internal registers or internal caches or in memory 244 (as opposed to storage 248 or elsewhere) and may operate only on data in one or more internal registers or internal caches or in memory 244 (as opposed to storage 248 or elsewhere).

In particular embodiments, storage 248 may include mass storage for data or instructions. As an example and not by way of limitation, storage 248 may include a hard disk drive (HDD), a floppy disk drive, flash memory, an optical disc, a magneto-optical disc, magnetic tape, or a Universal Serial Bus (USB) drive or a combination of two or more of these. Storage 248 may include removable or non-removable (or fixed) media, where appropriate. Storage 248 may be internal or external to the information handling system 200, where appropriate. In particular embodiments, storage 248 may be non-volatile, solid-state memory. In particular embodiments, storage 248 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 248 may take any suitable physical form and may comprise any suitable number or type of storage. Storage 248 may include one or more storage control units facilitating communication between processor 242 and storage 248, where appropriate.

In particular embodiments, interface 246 may include hardware, encoded software, or both providing one or more interfaces for communication (such as, for example, packet-based communication) among any networks, any network devices, and/or any other computer systems. As an example and not by way of limitation, communication interface 246 may include a network interface controller (NIC) or network adapter for communicating with an Ethernet or other wire-based network and/or a wireless NIC (WNIC) or wireless adapter for communicating with a wireless network.

Depending on the embodiment, interface 246 may be any type of interface suitable for any type of network for which information handling system 200 is used. As an example and not by way of limitation, information handling system 200 can include (or communicate with) an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, information handling system 200 can include (or communicate with) a wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these. The information handling system 200 may include any suitable interface 246 for any one or more of these networks, where appropriate.

In some embodiments, interface 246 may include one or more interfaces for one or more I/O devices. One or more of these I/O devices may enable communication between a person and the information handling system 200. As an example and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 246 for them. Where appropriate, interface 246 may include one or more drivers enabling processor 242 to drive one or more of these I/O devices. Interface 246 may include one or more interfaces 246, where appropriate.

Bus 252 may include any combination of hardware, software embedded in a computer readable medium, and/or encoded logic incorporated in hardware or otherwise stored (e.g., firmware) to couple components of the information handling system 200 to each other. As an example and not by way of limitation, bus 252 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 252 may include any number, type, and/or configuration of buses 252, where appropriate. In particular embodiments, one or more buses 252 (which may each include an address bus and a data bus) may couple processor 242 to memory 244. Bus 252 may include one or more memory buses.

Herein, reference to a computer-readable storage medium encompasses one or more tangible computer-readable storage media possessing structures. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements one or more portions of processor 242 (such as, for example, one or more internal registers or caches), one or more portions of memory 244, one or more portions of storage 248, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Perl, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

FIG. 3 illustrates an example of a process 300 for identifying computer-performance events. For example, the process 300, in whole or in part, can be implemented by one or more of the computing management system 110, the event logging module 130, the supplemental logging module 132, the categorization module 134 and/or the interface 136. The process 300 can also be performed generally by the computing environment 100. Although any number of systems, in whole or in part, can implement the process 300, to simplify discussion, the process 300 will be described in relation to the event logging module 130.

At block 302, the event logging module 130 monitors the resources 102 for computer-performance events. At decision block 304, the event logging module 130 determines whether a computer-performance event has occurred. If not, the process 300 returns to block 302 and proceeds as described above. Otherwise, if it is determined at decision block 304 that one or more computer-performance events have occurred, the event logging module 130 processes the computer-performance events at block 306. The processing can include logging the computer-performance event in the data store 138. From block 306, the process 300 returns to block 302 and proceeds as described above. The process 300 can continue until terminated (e.g., by an administrator or other user) or suitable stop criteria is satisfied.

FIG. 4 illustrates an example of a process 400 for performing supplemental logging of computer-performance events. For example, the process 400, in whole or in part, can be implemented by one or more of the computing management system 110, the event logging module 130, the supplemental logging module 132, the categorization module 134 and/or the interface 136. The process 400 can also be performed generally by the computing environment 100. Although any number of systems, in whole or in part, can implement the process 400, to simplify discussion, the process 400 will be described in relation to the supplemental logging module 132.

At block 402, the supplemental logging module 132 monitors an event logging process for computer-performance events. As described above, the supplemental logging module 132 can execute in parallel to an event logging module such as the event logging module 130 of FIG. 1. In certain embodiments, the monitored event logging process can be the event logging module 130 of FIG. 1. In an example, the block 402 can include checking the data store 138 for new log entries.

At decision block 404, the supplemental logging module 132 determines whether any new computer-performance events have been identified by the event logging module 130. If not, the process 400 returns to block 402 and proceeds as described above. Otherwise, if it is determined at decision block 404 that one or more new computer-performance events have been identified, at block 406, the supplemental logging module 132 records the computer-performance events in a supplemental log in the data store 142 or other memory. As mentioned previously, in some cases, the supplemental logging module 132 can filter events using configurable criteria so as to reduce a number of events processed by the categorization module 134. From block 406, the process 400 returns to block 402 and proceeds as described above. The process 400 can continue until terminated (e.g., by an administrator or other user) or suitable stop criteria is satisfied.

FIG. 5 illustrates an example of a process 500 for performing supplemental logging of computer-performance events. For example, the process 500, in whole or in part, can be implemented by one or more of the computing management system 110, the event logging module 130, the supplemental logging module 132, the categorization module 134 and/or the interface 136. The process 500 can also be performed generally by the computing environment 100. Although any number of systems, in whole or in part, can implement the process 500, to simplify discussion, the process 500 will be described in relation to the categorization module 134.

At block 502, the categorization module 134 monitors for categorization triggers. In various cases, categorization can be triggered automatically at regular intervals during runtime of the resources 102. The categorization can also be triggered in response to an event, manually by administrator or other user, etc. In addition, in some cases, the categorization module 134 can execute repeatedly such that, in essence, there is always a categorization trigger as long as there are new log entries in a supplemental log of the data store 142. At decision block 504, the categorization module 134 determines whether a categorization trigger has been detected. If not, the process 500 returns to block 502 and proceeds as described above. Otherwise, if it is determined at decision block 504 that a categorization trigger has been detected, the process 500 proceeds to block 506. At block 506, the categorization module 134 parses log entries of a supplemental log in the data store 142.

At block 508, the categorization module 134 dynamically determines processing rules of the data store 140 that are applicable to the parsed log entries. In various embodiments, the processing rules that are applicable can vary based, at least in part, on a particular supplemental log from which the log entries were parsed, a resource to which the log entries relate, or other criteria. In some embodiments, all processing rules of the data store 140 can be deemed applicable such that the block 508 includes retrieving the processing rules of the data store 140. As described previously, in various implementations, the processing rules of the data store 142 can be dynamically updated at runtime. For example, the categorization module 134 can periodically receive a new or updated processing rule during execution and store the new or updated processing rule in the data store 140. Advantageously, in these implementations, the new or updated processing rule can be dynamically determined at block 508 and used in the upcoming categorization iteration.

At block 510, the categorization module 134 categorizes the parsed log entries using the dynamically determined processing rules. In some embodiments, the block 510 can include determining a category of each of the parsed log entries. In an example, the processing rules of the data store 140 could be directed to identifying log entries related to a same transaction or request, log entries related to particular type of event (e.g., permissions issues, connectivity issues, etc.,), combinations of same and/or the like. According to this example, the block 510 can include categorizing the parsed log entries by transaction, type of event, etc. In some cases, the categorizations can be stored in a data store such as the data store 140 or in other memory.

At block 512, the categorization module 134 publishes a result of the categorization to the interface 136. For example, the block 512 can include publishing the determined categories, information related to a number of log entries in each of the determined categories, combinations of same and/or the like. From block 512, the process 500 returns to block 502 and executes as described above. The process 500 can continue until terminated (e.g., by an administrator or other user) or suitable stop criteria is satisfied.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A method comprising:
executing a first logging process, a second logging process and a categorization process in parallel on a computer system, wherein the first logging process identifies computer-performance events at a monitored resource;
the second logging process monitoring the first logging process for the computer-performance events;
responsive to the monitoring, as particular computer-performance events at the monitored resource are detected, the second logging process recording the particular computer-performance events in a data store;
the categorization process parsing log entries of the second logging process;
responsive to the parsing, the categorization process dynamically determining processing rules that are applicable to the parsed log entries;
the categorization process categorizing the parsed log entries using the dynamically determined processing rules; and
the categorization process publishing a result of the categorizing to an interface.

2. The method of claim 1, wherein:
the categorizing comprises determining a category of each of the parsed log entries; and
the publishing comprises publishing each determined category to the interface.

3. The method of claim 1, wherein the data store comprises file-based storage of information related to the particular computer-performance events.

4. The method of claim 1, wherein the categorization process performs the parsing periodically during runtime of the monitored resource.

5. The method of claim 1, comprising, by the categorization process:
receiving a new processing rule during execution;
storing the new processing rule; and
using the new processing rule in a next iteration of the categorizing.

6. The method of claim 1, comprising, by the categorization process:
receiving an updated processing rule during execution;
storing the updated processing rule; and
using the updated processing rule in a next iteration of the categorizing.

7. The method of claim 1, wherein the categorizing results in the parsed log entries being related together in a way which the parsed log entries were not already related together by the first logging process or the second logging process.

8. An information handling system comprising a processor, wherein the processor is operable to implement a method comprising:
executing a first logging process, a second logging process and a categorization process in parallel on a computer system, wherein the first logging process identifies computer-performance events at a monitored resource;
the second logging process monitoring the first logging process for the computer-performance events;
responsive to the monitoring, as particular computer-performance events at the monitored resource are detected, the second logging process recording the particular computer-performance events in a data store;
the categorization process parsing log entries of the second log;
responsive to the parsing, the categorization process dynamically determining processing rules that are applicable to the parsed log entries;
the categorization process categorizing the parsed log entries using the dynamically determined processing rules; and
the categorization process publishing a result of the categorizing to an interface.

9. The information handling system of claim 8, wherein:
the categorizing comprises determining a category of each of the parsed log entries; and
the publishing comprises publishing each determined category to the interface.

10. The information handling system of claim 8, wherein the data store comprises file-based storage of information related to the particular computer-performance events.

11. The information handling system of claim 8, wherein the categorization process performs the parsing periodically during runtime of the monitored resource.

12. The information handling system of claim 8, the method comprising, by the categorization process:
receiving a new processing rule during execution;
storing the new processing rule; and
using the new processing rule in a next iteration of the categorizing.

13. The information handling system of claim 8, the method comprising, by the categorization process:
receiving an updated processing rule during execution;
storing the updated processing rule; and
using the updated processing rule in a next iteration of the categorizing.

14. The information handling system of claim 8, wherein the categorizing results in the parsed log entries being related together in a way which the parsed log entries were not already related together by the first logging process or the second logging process.

15. A computer-program product comprising a non-transitory computer-usable medium having computer-readable program code embodied therein, the computer-readable program code adapted to be executed to implement a method comprising:
executing a first logging process, a second logging process and a categorization process in parallel on a computer system, wherein the first logging process identifies computer-performance events at a monitored resource;
the second logging process monitoring the first logging process for the computer-performance events;
responsive to the monitoring, as particular computer-performance events at the monitored resource are detected, the second logging process recording the particular computer-performance events in a data store;
the categorization process parsing log entries of the second log;
responsive to the parsing, the categorization process dynamically determining processing rules that are applicable to the parsed log entries;
the categorization process categorizing the parsed log entries using the dynamically determined processing rules; and
the categorization process publishing a result of the categorizing to an interface.

16. The computer-program product of claim 15, wherein:
the categorizing comprises determining a category of each of the parsed log entries; and
the publishing comprises publishing each determined category to the interface.

17. The computer-program product of claim 15, wherein the data store comprises file-based storage of information related to the particular computer-performance events.

18. The computer-program product of claim 15, wherein the categorization process performs the parsing periodically during runtime of the monitored resource.

19. The computer-program product of claim 15, the method comprising, by the categorization process:
receiving a new processing rule during execution;
storing the new processing rule; and
using the new processing rule in a next iteration of the categorizing.

20. The computer-program product of claim 15, the method comprising, by the categorization process:
receiving an updated processing rule during execution;
storing the updated processing rule; and
using the updated processing rule in a next iteration of the categorizing.
